(19) United States
(12) Patent Application Publication
(10) Pub. No.: US 2010/0250293 A1
(43) Pub. Date: Sep. 30, 2010

(54) SOA POLICY VERSIONING

(75) Inventors: Kishore Channabasavaiah, Palatine, IL (US); Benjamin S. Gerber, Ann Arbor, MI (US); Sri Ramanathan, Lutz, FL (US); Matthew B. Trevathan, Kennesaw, GA (US); Raghu Varadan, San Francisco, CA (US); Nevenko Zunic, Hopewell Junction, NY (US)

Correspondence Address: Driggs, Hogg, Daugherty & Del Zoppo Co., L.P.A., 38500 CHARDON ROAD, DEPT. IEN, WILLOUGHBY HILLS, OH, 44094, US

(73) Assignee: International Business Machines Corporation, Armonk, NY (US)

(21) Appl. No.: 12/410,488

(22) Filed: Mar. 25, 2009

(51) Int. Cl. G06Q 10/00; G06F 17/30

(52) U.S. Cl. 705/7; 707/E17.014

(57) ABSTRACT

Methods, including service methods, articles of manufacture, systems, articles and programmable devices are provided for controlling versioning of a service. A programmable policy broker is configured to communicate with a service registry and a policy repository comprising different service levels of a service. A location lookup is centralized in the service registry for different versions of the service. A call for a service by a consumer is mediated by causing the policy broker to select and return a correct service level from the policy repository as a function of a requirement of the consumer, look up a proper version of the service in the service registry from the different versions as a function of the returned correct service level, and call the looked-up proper service from a location associated with the proper service in the service registry.

### FIELD OF THE INVENTION

The present invention generally describes methods, systems and devices for controlling versioning of a service returned to a consumer.

### BACKGROUND OF THE INVENTION

Changing business needs over time may result in the creation of complex, inflexible application architectures, often with high levels of redundancy of business functions and data. To ensure that business needs drive information technology (IT) solutions many organizations desire to break down application “silos”, wherein the deployment of multiple IT systems such as enterprise resource planning (ERP), customer relationship management (CRM), data warehouses, customer portals and content management systems results in incomplete and inconsistent pictures of corporate information and project or group-specific business functions. More particularly, it is desired to increase focus on building IT integration capabilities to develop and deploy shareable and reusable services that may be used across lines of business and across processes in a manner dictated by business needs and not by the application or information technology (IT) architecture.

Organizations are increasingly turning to service-oriented architecture (SOA) methods, systems and governance models to develop and deploy shareable and reusable services. An SOA governance model provides a framework that enables an organization to come to a consensus on the scope of SOA governance and its definition and use, and one common SOA governance problem with respect to a services lifecycle centers on the versioning of services. In many cases, it may become necessary to have multiple versions of a service or “release” of a service to meet the needs of various entities in an organization or business. Problems arise in offering a unified method where each consumer can get both an appropriate service and the correct version of that service from an SOA.

### SUMMARY OF THE INVENTION

Methods are provided for controlling versioning of a service. A programmable policy broker is provided, configured to communicate with a service registry and a policy repository, the policy repository comprising different service levels of a service. A location lookup is centralized in the service registry for different versions of the service wherein each of the different versions may have a separate location. A call for a service by a consumer is mediated by causing the policy broker to select and return a correct service level from the policy repository different service levels as a function of a requirement of the consumer, look up a proper version of the service needed by the consumer in the service registry from the different versions as a function of the returned correct service level, and call the looked-up proper service from a location associated with the proper service in the service registry.

Service methods are also provided comprising deploying applications for controlling versioning of a service according to the method steps described above, for example by a service provider who offers to implement, deploy, and/or perform functions for others. Still further, articles of manufacture comprising a computer usable medium having a computer readable program in said medium are provided. Such program code comprises instructions which, when executed on a computer system, cause the computer system to perform one or more method and/or process elements described above for controlling versioning of a service. Moreover, systems, articles and programmable devices are also provided, configured for performing one or more method and/or process elements of the current invention for controlling versioning of a service, for example as described above.

### BRIEF DESCRIPTION OF THE DRAWINGS

These and other features of the methods, systems and devices according to the present application will be more readily understood from the following detailed description of the various aspects of the embodiments taken in conjunction with the accompanying drawings in which:

FIG. 1 is a flow chart illustrating a method and system for controlling versioning of a service according to the present invention.

FIG. 2 is diagrammatic illustration of an implementation of a method and system for controlling versioning of a service according to the present invention.

FIG. 3 is diagrammatic illustration of another implementation of a method and system for controlling versioning of a service according to the present invention.

FIG. 4 is a flow diagram is describing a service request and return according to the present invention.

FIG. 5 is a block diagram of a programmable system or device configured to control versioning of a service according to the present invention.

FIG. 6 is a block diagram illustrating a computerized implementation configured to control versioning of a service according to the present invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

For convenience, the Detailed Description of the Invention has the following sections:

I. General Description; and

II. Computerized Implementation.

### I. General Description

Examples of SOA aspects and governance processes according to the present invention may be found in the following commonly-owned and co-pending U.S. patent applications or issued U.S. patents, the disclosures of which are expressly incorporated herein by reference: “Identifying a Service Oriented Architecture Shared Services Project”, attorney docket no. END920080252US1, filed on (to be provided), and assigned application Ser. No. (to be provided); “Evaluating a Service Oriented Architecture Shared Services Project”, attorney docket no. END920080288US1, filed on (to be provided), and assigned application Ser. No. (to be provided); “Service Oriented Architecture Shared Service Inception”, attorney docket no. END920080289US1, filed on (to be provided), and assigned application Ser. No. (to be provided); “Service Oriented Architecture Shared Services Elaboration”, attorney docket no. END920080290US1, filed on (to be provided), and assigned application Ser. No. (to be provided); “Service Oriented Architecture Shared Services Construction”, attorney docket no. END920080291US1, filed on (to be provided), and assigned application Ser. No. (to be provided); “Transitioning to Management of a Service Oriented Architecture Shared Service”, attorney docket no. END920080292US1, filed on (to be provided), and assigned application Ser. No. (to be provided); “Service Oriented Architecture Shared Service Management”, attorney docket no. END920080293US1, filed on (to be provided), and assigned application Ser. No. (to be provided); “Service Oriented Architecture Shared Service Escalation”, attorney docket no. END920080294US1, filed on (to be provided), and was assigned application Ser. No. (to be provided); “FRAMEWORK FOR VARIATION ORIENTED ANALYSIS FOR SERVICE-ORIENTED ARCHITECTURE”, attorney docket no. END920080317US1-IEN106617, filed on (to be provided), and assigned application Ser. No. (to be provided); “TECHNICAL FEASIBILITY EXPLORATION FOR SERVICE-ORIENTED ARCHITECTURE ENVIRONMENTS”, attorney docket no. END920080318US1-IEN106618, filed on (to be provided), and assigned application Ser. No. (to be provided); “SOA Lifecycle Governance and Management”, attorney docket no. END920080319US1-IEN106619, filed on (to be provided), and assigned application Ser. No. (to be provided); “ENABLING SOA GOVERNANCE USING A SERVICE LIFECYCLE APPROACH”, attorney docket no. END920080320US1-IEN106620, filed on (to be provided), and assigned application Ser. No. (to be provided); “CALIBRATION FRAMEWORK FOR EFFORT ESTIMATION”, attorney docket no. END920080321US1-IEN106621, filed on (to be provided), and assigned application Ser. No. (to be provided); “SERVICE PORTFOLIO APPROACH FOR SOA GOVERNANCE”, attorney docket no. END920080386US1-IEN106642, filed on (to be provided), and assigned application Ser. No. (to be provided); “SERVICE EVOLUTION APPROACH IN SOA”, attorney docket no. END920080387US1-IEN106643, filed on (to be provided), and assigned application Ser. No. (to be provided); “CAPABILITY AND MATURITY-BASED SOA GOVERNANCE”, attorney docket no. END920080388US1-IEN106644, filed on (to be provided), and assigned application Ser. No. (to be provided); “PRIORITIZATION ENABLEMENT FOR SOA GOVERNANCE”, attorney docket no. END920080389US1-IEN106645, filed on (to be provided), and assigned application serial no. (to be provided); and “SOA POLICY ENGINE FRAMEWORK”, attorney docket no. END920080390US1-IEN106646, filed on (to be provided), and assigned application Ser. No. (to be provided).

It is often necessary for an SOA to provide multiple versions of a service or “release” of a service to meet the needs of various entities in an organization or business. Prior art SOA governance does not offer a unified method where a consumer can go to get a service and not have to worry about the version of the service that it needs. Universal Description, Discovery, and Integration (UDDI) registries and service registries alone cannot solve this problem because they do not know which version of the service that a consumer may need. This becomes an issue of SOA governance because there is not a defined method for handling service versioning in current SOA implementations.

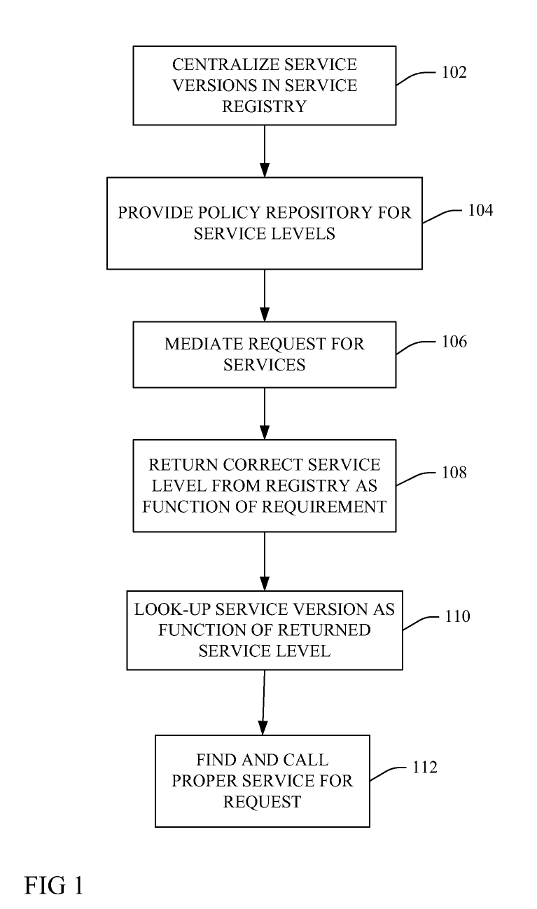

FIG. 1 is a flow chart illustrating a method and system for controlling versioning of a service. At 102 a location lookup structure is provided centralizing a plurality of versions of a service in a service registry, wherein each of the plurality of versions may have a separate location, and moreover the locations may be spread across different types of infrastructure, servers, operating systems, etc. At 104 a policy repository is provided comprising a plurality of service levels of the service. At 106 a call or request for a service by a consumer is received and mediated to the service registry and to a programmable policy broker communicating with the policy repository. At 108 the policy broker accordingly determines, selects and returns a correct service level from the plurality of service levels residing in the policy repository as a function of a requirement of the consumer. At 110 a proper version of the service needed by the consumer is looked-up in the service registry from the plurality of versions of the service as a function of the correct service level returned at 108. At 112 the policy broker calls the proper service from a location associated with the proper service in the service registry. In one aspect the policy broker may be configured to directly communicate with and call the proper service at 112 from a server or other IT infrastructure serving as the associated location, for example through a policy adapter configured to communicate with an associated location server.

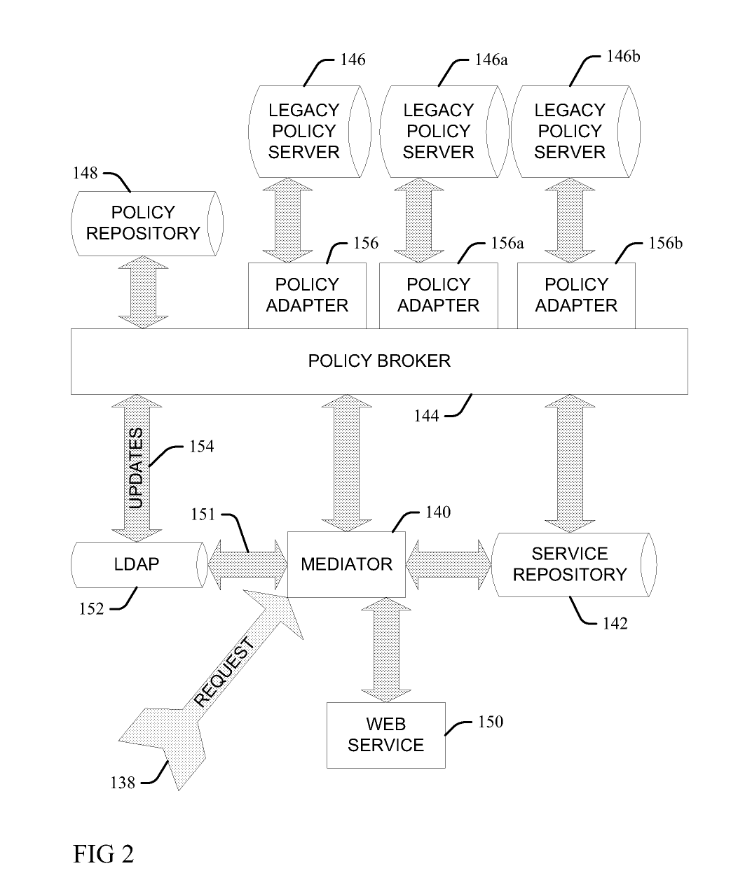

FIG. 2 is a block diagram illustrating one embodiment of the present invention, and components thereof will be understood by reference to the methods or processes described above and illustrated in FIG. 1. Thus, a programmable mediator 140 is provided, configured to communicate with a service repository 142 and a programmable policy broker 144, the policy broker 144 in communication with a policy repository 148. In response to a call or request 138 for a service by a consumer, the mediator 140 is configured to cause the policy broker 144 to select and return a correct service level, look-up a proper version of the service, and also to cause the policy broker 144 to call the proper service from at least one associated location of a plurality of possible legacy policy server locations 146, said at least one legacy policy server 146 associated with the proper service in the service registry 142.

The mediator 140 is also in communication with a web service 150 which may provide a web-based resource for the called/proper service returned in response to the consumer request 138. The mediator 140 is further configured to look-up the proper version of the service further by performing a key look-up query 151 of a Lightweight Directory Access Protocol (LDAP) application 152 in communication with the policy broker, wherein LDAP may be understood as an application protocol for and modifying directory services running over Transmission Control Protocol/Internet Protocol (TCP/IP). As will be appreciated by one skilled in the art, the LDAP 152 enables rapid and efficient look-ups through key look-up structures and processes, and key look-up data is kept current and useful through an updating process 154 linking the policy broker 144 and the LDAP 152.

In another aspect, the policy broker 144 directly communicates with and calls services from each of the plurality of location legacy policy servers 146 through policy adapters 156 configured to communicate with each associated location server. Thus, where legacy policy server 146a is a different type of server relative to legacy policy server 146b, the policy adapter 156a configured to enable the policy broker 144 to communicate with legacy policy server 146a is different than the policy adapter 156b, the policy adapters 156a and 156b enabling the policy broker 144 to automatically communicate with the different legacy policy servers 146a and 146b.

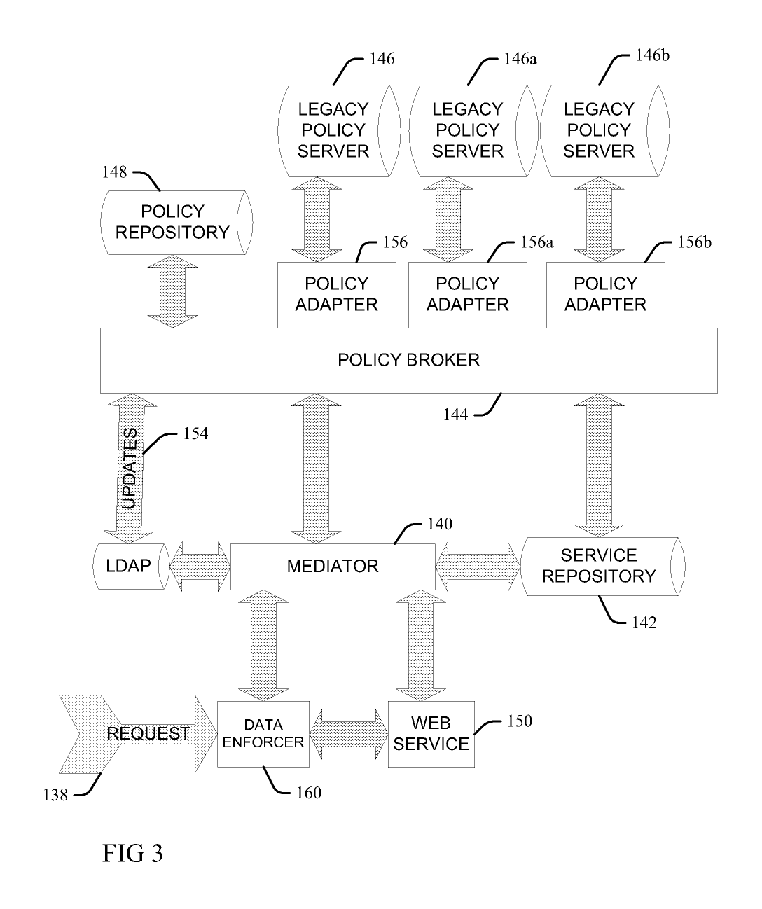

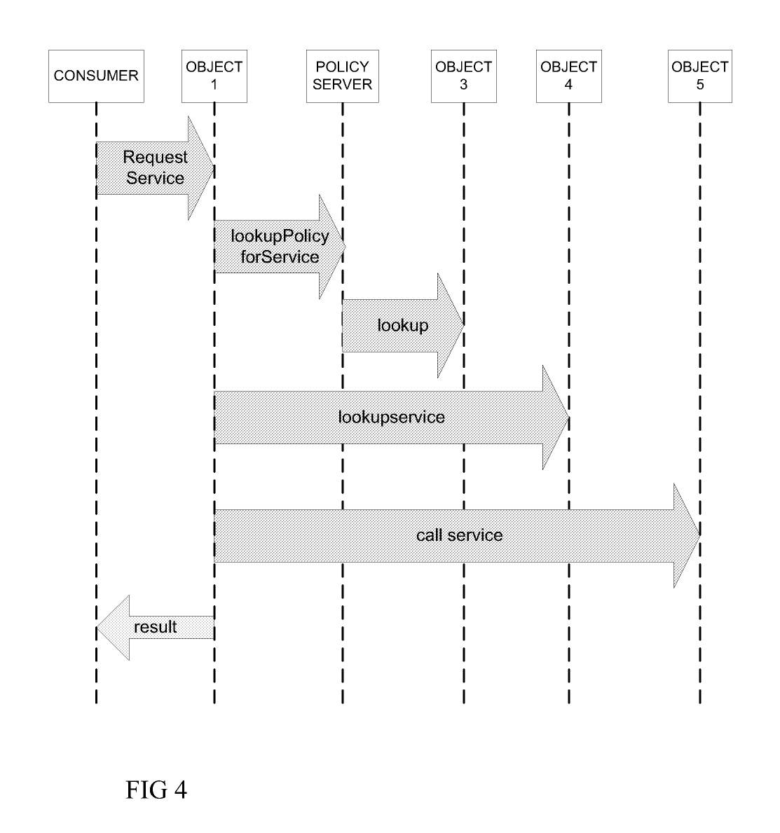

FIG. 3 is a block diagram illustrating another embodiment of the present invention, wherein a programmable data enforcer 160 is provided in communication with the mediator 140 and the web service 150 of FIG. 2, the data enforcer configured to receive the call for service 138 by the consumer and responsively generate a request to the mediator 140 and also to provide a web-based resource from the web service 150. The embodiment illustrated in FIG. 3 is thus understood by reference to the discussion of FIG. 2, wherein the mediator 140 is configured to interact with the data enforcer 160 to accomplish the processes and methods described above. FIG. 4 provides a flow diagram describing a service request and return according to the present invention as provided by the architecture of FIG. 2 or 3, more particularly describing an object-oriented nomenclature as will be understood by one skilled in the art.

The present invention thus defines processes combining the use of a service registry and a policy based server to control which version of a service is needed. Methods and processes are defined for controlling versioning of a service that allows a consumer to access different service levels implicitly via the use of version policies, making service versioning configuration, not code driven. Deprecating and sun setting services is also provided for by controlling access to a version of the service. A consumer's needs for a service are correlated to a correct service version using a policy-based system and centralizing the lookup of the service, offering a one call for all versions of a service without the consumer having to worry about the mechanics of calling different versions.

The present invention focuses on the use of policy architecture as a reference architecture for the implementation of embodiments of the invention, and focuses on the versioning of the services. Legacy policy lookups and access enforcement for security purposes are not primary concerns in some embodiments, although other embodiments may support and/or provide theses functions. By using the combination of a policy service and a registry, the present invention provides a method for offering different service versions of a service without requiring a consumer or other requester to recode specific versioning information into a service request.

Providing one mediation/brokering point for controlling versions via the policy repository 148, the present invention allows a consumer's request to be controlled via a configuration, not via code as required by the prior art. From a governance perspective, the called/returned service is now centrally controlled. Additionally, a lookup for a version of a service may look up a service as a function of the consumer's needs, and may offer a default version of a service if a consumer does not have a policy defined.

FIG. 5 illustrates a programmable device or module 200 configured to control versioning of a service according to the present invention, for example as illustrated in FIGS. 1-4 and described above. The device 200 may be incorporated into a larger system (such as one provided by a service provider) wherein other applications and components of the larger system accomplish systems and methods according to the present invention, or it may be a stand-alone device or module 200 configured to perform each of the systems and methods described above. The present embodiment comprises a central processing unit (CPU) or other processing means 201 in communication with a memory 203 comprising logic components that enable the CPU 201 to perform processes and methods according to the present application, as will be understood through reference to FIGS. 1-4 as discussed above. Thus, the memory 203 comprises a mediator logic component (e.g. algorithm, etc.) 202, for example configured to mediate service requests from a consumer to a policy broker logic component 204, a service registry, an LDAP and a web service, the policy broker 204 configured to communicate with a policy repository, legacy servers through policy adapters, the service registry and the LDAP. The present module 200 also has an optional data enforcer logic component 206, configured present an interface between the consumer request and the mediator component 202 and to communicate with a web service entity. However, it will be understood that in other embodiments one or more of the components 202, 204 and 206 may be omitted, and its functions or algorithms combined with others of the components 202, 204 and 206 or accomplished by other systems, components, elements or parties.

A power source 205 is configured to provide operative power to the device 200; examples include battery units 205 and power inputs configured to receive alternating or direct current electrical power, and other appropriate power units 205 will be apparent to one skilled in the art. A communication port or network link/node means (“com port”) 207 is also provided and configured to enable data and other communications as may be appropriate, for example as discussed above.

### II. Computerized Implementation

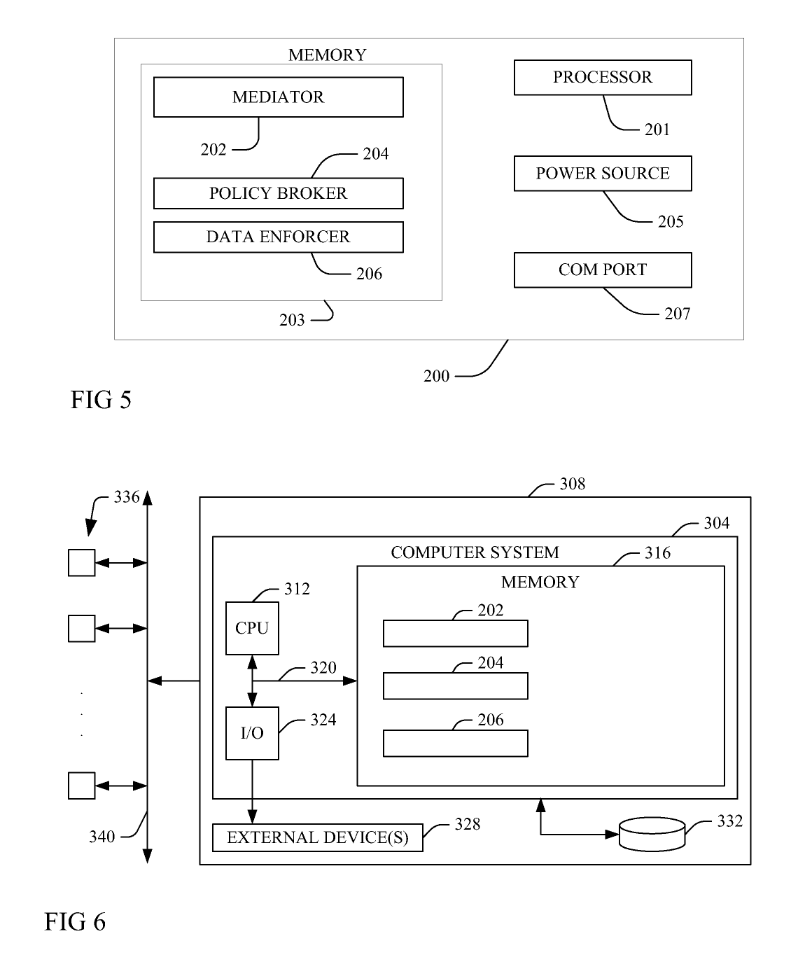

Referring now to FIG. 6, an exemplary computerized implementation of the present invention includes a computer system 304 a programmable device or module 200 configured to control versioning of a service according to the present invention and deployed within a computer infrastructure 308 such as a computer or a programmable device such as a personal digital assistant (PDA) or cellular phone. This is intended to demonstrate, among other things, that the present invention could be implemented within a network environment 340 (e.g., the Internet, a wide area network (WAN), a local area network (LAN), a virtual private network (VPN), etc.) in communication with one or more additional computers 336 (e.g. a legacy server 146 discussed above), or on a stand-alone computer infrastructure 308. In the case of the former, communication throughout the network 340 can occur via any combination of various types of communication links. For example, the communication links can comprise addressable connections that may utilize any combination of wired and/or wireless transmission methods. Where communications occur via the Internet, connectivity could be provided by conventional TCP/IP sockets-based protocol, and an Internet service provider could be used to establish connectivity to the Internet.

As shown, the computer system 304 includes a central processing unit (CPU) 312, a memory 316, a bus 320, and input/output (I/O) interfaces 324. Further, the computer system 304 is shown in communication with external I/O devices/resources 328 and storage systems 332 (e.g. the service registry 142, the policy repository 148, the web service entity 150 and the LDAP 152 as discussed above). In general, the processing unit 312 executes computer program code, such as the code to implement various components of the process and systems, and devices as illustrated in FIGS. 1-3 and described above, including the mediator logic component 202, the policy broker logic component 204 and the optional data enforcer logic component 206 discussed above, and which are stored in memory 316 and/or storage system 332. It is to be appreciated that two or more, including all, of these components may be implemented as a single component.

While executing computer program code, the processing unit 312 can read and/or write data to/from the memory 316, the storage system 332 (e.g. the, and/or the I/O interfaces 324. The bus 320 provides a communication link between each of the components in computer system 304. The external devices 328 can comprise any devices (e.g., keyboards, pointing devices, displays, etc.) that enable a user to interact with computer system 304 and/or any devices (e.g., network card, modem, etc.) that enable computer system 304 to communicate with one or more other computing devices.

The computer infrastructure 308 is only illustrative of various types of computer infrastructures for implementing the invention. For example, in one embodiment, computer infrastructure 308 comprises two or more computing devices (e.g., a server cluster) that communicate over a network to perform the various process steps of the invention. Moreover, computer system 304 is only representative of various possible computer systems that can include numerous combinations of hardware.

To this extent, in other embodiments, the computer system 304 can comprise any specific purpose-computing article of manufacture comprising hardware and/or computer program code for performing specific functions, any computing article of manufacture that comprises a combination of specific purpose and general-purpose hardware/software, or the like. In each case, the program code and hardware can be created using standard programming and engineering techniques, respectively. Moreover, the processing unit 312 may comprise a single processing unit, or be distributed across one or more processing units in one or more locations, e.g., on a client and server. Similarly, the memory 316 and/or the storage system 332 can comprise any combination of various types of data storage and/or transmission media that reside at one or more physical locations.

Further, I/O interfaces 324 can comprise any system for exchanging information with one or more of the external device 328. Still further, it is understood that one or more additional components (e.g., system software, math co-processing unit, etc.) not shown in FIG. 6 can be included in computer system 304. However, if computer system 304 comprises a handheld device or the like, it is understood that one or more of the external devices 328 (e.g., a display) and/or the storage system 332 could be contained within computer system 304, not externally as shown.

The storage system 332 can be any type of system (e.g., a database) capable of providing storage for information under the present invention. To this extent, the storage system 332 could include one or more storage devices, such as a magnetic disk drive or an optical disk drive. In another embodiment, the storage system 332 includes data distributed across, for example, a local area network (LAN), wide area network (WAN) or a storage area network (SAN) (not shown). In addition, although not shown, additional components, such as cache memory, communication systems, system software, etc., may be incorporated into computer system 304.

While shown and described herein as a method and a system, it is understood that the invention further provides various alternative embodiments. For example, in one embodiment, the invention provides a computer-readable/useable medium that includes computer program code to enable a computer infrastructure to implement methods, systems and devices according to the present application, for example as illustrated in FIGS. 1-4 above and described otherwise herein. To this extent, the computer-readable/useable medium includes program code that implements each of the various process steps of the present application.

It is understood that the terms “computer-readable medium” or “computer useable medium” comprise one or more of any type of physical embodiment of the program code. In particular, the computer-readable/useable medium can comprise program code embodied on one or more portable storage articles of manufacture (e.g., a compact disc, a magnetic disk, a tape, etc.), on one or more data storage portions of a computing device, such as the memory 316 and/or the storage system 332 (e.g., a fixed disk, a read-only memory, a random access memory, a cache memory, etc.), and/or as a data signal (e.g., a propagated signal) traveling over a network (e.g., during a wired/wireless electronic distribution of the program code).

Still yet, computer infrastructure 308 is intended to demonstrate that some or all of the components of implementation according to the present application could be deployed, managed, serviced, etc. by a service provider who offers to implement, deploy, and/or perform the functions of the present invention for others, for example by licensing methods and browser or application server technology to an internet service provider (ISP) or a cellular telephone provider. In one embodiment the invention may comprise a business method that performs the process steps of the invention on a subscription, advertising, and/or fee basis. Thus a service provider can create, maintain, support, etc., a computer infrastructure, such as the computer infrastructure 308 that performs the process steps of the present application for one or more customers, and in return the service provider can receive payment from the customer(s) under a subscription and/or fee agreement and/or the service provider can receive payment from the sale of advertising content to one or more third parties.

In still another embodiment, the invention provides a computer-implemented method for enabling the processes, methods and devices according to the present application. In this case, a computer infrastructure, such as computer infrastructure 308, can be provided and one or more systems for performing the process steps of the invention can be obtained (e.g., created, purchased, used, modified, etc.) and deployed to the computer infrastructure. To this extent, the deployment of a system can comprise one or more of: (1) installing program code on a computing device, such as computer system 304, from a computer-readable medium; (2) adding one or more computing devices to the computer infrastructure; and (3) incorporating and/or modifying one or more existing systems of the computer infrastructure to enable the computer infrastructure to perform the process steps of the invention.

As used herein, it is understood that the terms “program code” and “computer program code” are synonymous and mean any expression, in any language, code or notation, of a set of instructions intended to cause a computing device having an information processing capability to perform a particular function either directly or after either or both of the following: (a) conversion to another language, code or notation; and/or (b) reproduction in a different material form. To this extent, program code can be embodied as one or more of: an application/software program, component software/a library of functions, an operating system, a basic I/O system/driver for a particular computing and/or I/O device, and the like. Computer readable media can be any available media that can be accessed by a computer. By way of example, and not limitation, computer readable media may comprise “computer storage media” and “communications media.”

“Computer storage media” include volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

“Communication media” typically embodies computer readable instructions, data structures, program modules, or other data in a modulated data signal, such as carrier wave or other transport mechanism. Communication media also includes any information delivery media.

The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above are also included within the scope of computer readable media.

Certain examples and elements described in the present specification, including in the claims and as illustrated in the Figures, may be distinguished or otherwise identified from others by unique adjectives (e.g. a “first” element distinguished from another “second” or “third” of a plurality of elements, a “primary” distinguished from a “secondary,” an “another”, etc.) Such identifying adjectives are generally used to reduce confusion or uncertainty, and are not to be construed to limit the claims to any specific illustrated element or embodiment, or to imply any precedence, ordering or ranking of any claim elements, limitations or process steps.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

What is claimed is:

1. A method for controlling versioning of a service, comprising:
providing a programmable policy broker configured by a logic component to communicate with a service registry and a policy repository, the policy repository comprising a plurality of different service levels of a service;
centralizing a location lookup in the service registry for a plurality of different versions of the service wherein each of the plurality of different versions may have a separate location; and
mediating a call for a service by a consumer by
causing the policy broker to select and return a correct service level from the plurality of different service levels from the policy repository as a function of a requirement of the consumer;
looking up a proper version of the service needed by the consumer in the service registry from the plurality of different versions of the service as a function of the returned correct service level; and
causing the policy broker to call the looked-up proper service from a location associated with the proper service in the service registry.

2. The method of claim 1, wherein the mediating further comprises communicating with a web service to provide a web-based resource for the called proper service.

3. The method of claim 2, wherein the mediating further comprises looking up the proper version of the service further by performing a key look-up query of a lightweight directory access protocol application.

4. The method of claim 3, wherein the location associated with the proper service is an associated location server, wherein the mediating further comprises causing the policy broker to directly communicate with and call the proper service from the associated location server through a policy adapter.

5. The method of claim 4, wherein the mediating further comprises receiving the call for the service by the consumer and responsively generating a request for the service to provide the web-based resource for the called proper service.

6. The method of claim 1, further comprising:
a service provider deploying the programmable policy broker configured to centralize the location lookup in the service registry for the plurality of different versions of the service; and
the service provider deploying a programmable mediator in communication with the service registry and the policy broker;
wherein the mediator is configured to mediate the call for the service by the consumer by causing the policy broker to select and return the correct service level from the plurality of different service levels from the policy repository as a function of a requirement of the consumer, look up the proper version of the service needed by the consumer in the service registry as a function of the returned correct service level, and call the looked-up proper service from the location associated with the proper service in the service registry.

7. The method of claim 6, wherein the mediator is further configured to communicate with a web service to provide a web-based resource for the called proper service.

8. The method of claim 7, wherein the mediator is further configured to look up the proper version of the service further by performing a key look-up query of a lightweight directory access protocol application in communication with the policy broker.

9. The method of claim 8, wherein the location associated with the proper service is an associated location server, and wherein the policy broker is further configured to directly communicate with and call the proper service from the associated location server through a policy adapter configured to communicate with the associated location server.

10. The method of claim 9, wherein the mediator is further configured to communicate with a programmable data enforcer and the web service, the data enforcer configured to receive the call for the service by the consumer and responsively generate a request to the mediator for the service through the mediator and to provide the web-based resource for the called proper service.

11. A method for controlling versioning of a service, comprising:
producing computer executable program code;
storing the code on a computer readable medium; and
providing the program code to be deployed and executed on a computer system, the program code comprising instructions which, when executed on the computer system, cause the computer system to:
communicate with a service registry and a policy repository, the policy repository comprising a plurality of different service levels of a service;
centralize a location lookup in the service registry for a plurality of different versions of the service wherein each of the plurality of different versions may have a separate location; and
mediate a call for a service by a consumer by
selecting and returning a correct service level from the plurality of different service levels from the policy repository as a function of a requirement of the consumer;
looking up a proper version of the service needed by the consumer in the service registry from the plurality of different versions of the service as a function of the returned correct service level; and
call the looked-up proper service from a location associated with the proper service in the service registry.

12. The method of claim 11, the program code comprising instructions which, when executed on the computer system, causes the computer system to communicate with a web service to provide a web-based resource for the called proper service.

13. The method of claim 12, the program code comprising instructions which, when executed on the computer system, causes the computer system to look up the proper version of the service further by performing a key look-up query of a lightweight directory access protocol application in communication with the computer system.

14. The method of claim 13, the program code comprising instructions which, when executed on the computer system, causes the computer system to directly communicate with and call the proper service from a location associated with the proper service on an associated location server through a policy adapter configured to communicate with the associated location server.

15. The method of claim 14, the program code comprising instructions which, when executed on the computer system, causes the computer system to communicate with a programmable data enforcer, wherein the data enforcer is configured to receive the call for the service by the consumer and responsively generate a request to the computer system for the service and to provide the web-based resource for the called proper service.

16. A programmable device comprising:
a processing means;
a service registry and a policy repository in communication with the processing means, the policy repository comprising a plurality of different service levels of a service; and
a network interface in communication with the processing means the service registry and the policy repository;
wherein the processing means is configured to:
centralize a location lookup in the service registry for a plurality of different versions of the service wherein each of the plurality of different versions may have a separate location; and
mediate a call for a service by a consumer by
selecting and returning a correct service level from the plurality of different service levels from the policy repository as a function of a requirement of the consumer;
looking up a proper version of the service needed by the consumer in the service registry from the plurality of different versions of the service as a function of the returned correct service level; and
call the looked-up proper service from a location associated with the proper service in the service registry.

17. The programmable device of claim 16, wherein the processing means is further configured to communicate with a web service to provide a web-based resource for the called proper service.

18. The programmable device of claim 17, wherein the processing means is further configured to look up the proper version of the service further by performing a key look-up query of a lightweight directory access protocol application.

19. The programmable device of claim 18, wherein the processing means is further configured to directly communicate with and call the proper service from a location associated with the proper service on an associated location server through a policy adapter configured to communicate with the associated location server.

20. The programmable device of claim 19, wherein the processing means is further configured to communicate with a programmable data enforcer configured to receive the call for the service by the consumer and responsively generate a request to the computer system for the service and to provide the web-based resource for the called proper service.
